(19) United States
(12) Patent Application Publication
(10) Pub. No.: US 2026/0346168 A1
(43) Pub. Date: Nov. 5, 2026

(54) VOID SPAN REDUCING STRUCTURES IN A CHEMICAL REACTOR

(71) Applicant: PharmaFluidics NV, Gent-Zwijnaarde (BE)

(72) Inventors: Bo Claerebout, Kortrijk (BE); Paul Jacobs, Lokeren (BE); Jeff Op de Beeck, Mariakerke (BE)

(21) Appl. No.: 19/487,254

(22) PCT Filed: May 24, 2024
(86) PCT No.: PCT/EP2024/064441

§ 371 Date: Nov. 24, 2025

Related U.S. Application Data
(60) Provisional application No. 63/504,239, filed on May 25, 2023.

(51) Int. Cl. B01D 29/44; B01D 15/12; B01D 29/03; B01D 29/56; B01D 29/90; B01D 29/92; G01N 30/84

(52) U.S. Cl. CPC B01D 29/445; B01D 15/125; B01D 29/03; B01D 29/56; B01D 29/902; B01D 29/925; G01N 30/84

(57) ABSTRACT

A chemical reactor including an inlet, a filter and a separation or processing element is described. The inlet has an inlet depth. The filter includes a first duct has a depth of dhigh and one or more support pillars, a second duct included a second duct depth of dlow and filter pillars, and a transition region including a step from dhigh to dlow as well as a transition pillar spanning the transition region.

### CROSS-REFERENCE TO RELATED APPLICATIONS

This application claims the benefit of priority to U.S. Provisional Application No. 63/504,239, filed May 25, 2023, the entire contents of which is incorporated herein by reference.

### FIELD OF THE INVENTION

This invention generally relates to chemical reactors such as for a chromatographic system. More specifically, the present invention relates to support structures to avoid large void spans in chemical reactors.

### BACKGROUND OF THE INVENTION

Systems that make use of liquid propagation have a large number of applications, including production of chemical components, synthesis of nanoparticles, separation and/or extraction of components, etc. A specific example of a separation technique for separating mixtures (for example, to accurately analyze them) is chromatography. There is variation among the forms of chromatography such as gas chromatography, gel chromatography, thin-coating chromatography, adsorption chromatography, affinity chromatography, liquid chromatography, etc. Liquid chromatography is typically used in pharmacy and chemistry, for both analytical and production applications. In liquid chromatography, use is made of the difference in solubility of various substances in a mobile phase and a stationary phase. As each substance has its own “retention power” (solubility) to the stationary phase, they are moved along faster or slower with the mobile phase and as such, certain substances may be separated from other ones.

A typical example of liquid chromatography is based on chromatographic columns in the form of a channel in a substrate that includes a stationary phase to achieve separation of the chemical components in a sample. Each channel can have geometrical features to alter or improve fluid flow or separation. In some cases, multiple channels can be interconnected in series to improve the separation efficiency.

### SUMMARY

Systems, methods, and products to address these and other needs are described herein with respect to illustrative, non-limiting, implementations. Various alternatives, modifications and equivalents are possible.

According to an aspect, a chemical reactor implemented on a substrate is described. The chemical reactor includes an inlet including an inlet depth, a filter fluidly connected to the inlet through a filter entrance, and a separation or processing element fluidly connected to the filter through a filter exit. The filter includes a first duct including a first duct depth of dhigh, and one or more support pillars spanning the first duct in a depth direction. The filter also includes a second duct including a second duct depth of dlow and filter pillars spanning the second duct in the depth direction. A transition region connects the first duct to the second duct. The transition region includes a transition depth of dhigh proximate to the first duct and dlow proximate to the second duct. A transition pillar spans the transition region in the depth direction as well as in an average flow direction.

The chemical reactor is designed to provide efficient filtering with a high-pressure compliance.

### BRIEF DESCRIPTION OF THE DRAWINGS

The foregoing and other features and advantages of the present embodiments will be more fully understood from the following detailed description of illustrative embodiments taken in conjunction with the accompanying drawings.

FIG. 1 shows top-down view of a prior art arrangement of a chemical reactor implemented on a substrate.

FIG. 2 shows the prior art arrangement after failure at a high pressure.

FIG. 3 is a top-down view of a chemical reactor implemented on a substrate, according to some implementations.

FIG. 4 is a side view showing details of a filter, according to some implementations.

FIG. 5A shows a top-down view of the structure of a first duct and a portion of the transition region including the support pillars, according to some implementations. FIG. 5B shows a top-down view of a comparative duct arrangement.

FIG. 6 is top-down view of a duct and a portion of the transition region shown in FIG. 5A.

FIG. 7A includes square support pillars, according to some implementations. FIG. 7B shows another structure including square support pillars, according to some implementations.

FIG. 8A shows a structure where brick shaped support pillars are used, according to some implementations. FIG. 8B shows a structure where multiple pillar structure shapes are used in a single filter, according to some implementations. FIG. 8C shows a structure where stretched out hexagonal pillars are used, according to some implementations.

FIG. 9 illustrates a detail of a transition region in the chemical reactor according to FIG. 3.

FIG. 10 is a block diagram of a chemical reactor, according to some implementations.

FIG. 11 is a schematic of a chromatography system, according to some implementations.

FIG. 12 is a top view of a first mask to perform deep etch step, according to some implementations.

FIG. 13 is a top view of a second mask to perform a shallow etch step, according to some implementations.

FIG. 14 shows a detail of part of a chemical reactor, according to some implementations.

FIG. 15 is a bar graph showing pressure compliance.

The figures referred to above are not drawn necessarily to scale, should be understood to provide a representation of particular embodiments, and are merely conceptual in nature and illustrative of the principals involved. The same reference numbers are used in the drawings for similar or identical components and features shown in various alternative embodiments.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the statistical dispersion found in their respective testing measurements.

It is well known that various problems may manifest at the inlet of ducts for chemical reactors performing separation of chemical components. One known problem is accurately mounting the various components in the chromatographic column, for example, mounting the capillary that supplies the fluid to the inlet of a duct in the chemical reactor which is implemented on a substrate.

A second known problem relates to partial or complete blockages of the inlet at the entrance of the duct by agglomerations or other undesirable components of the sample to be analyzed. This phenomenon can occur at the level of the distributor, which has as its function the widening of the fluid plug from the smaller initial width at the inlet to fill the width of the downstream duct in which the separation occurs.

One solution to these problems is to provide a filter element such as the filter described in Op De Beeck et al., US Patent Application Publication Serial No. US20220057370A1, which is hereby incorporated by reference in its entirety. The solution includes providing a deep etch area where the capillary can be inserted and mounted and a widening area that feeds to a filter which is in a shallow etch area. However, the widening area with the deep etch cannot create instability of the chemical reactor device when high pressure fluid is applied. Above a critical pressure, the use of a wide void span between the walls of the structure can cause cracks or damage to form. The problem is not easily resolvable by lowering the pressure as pressure reduction also lowers device throughput, thus sacrificing the advantages of the substrate-defined chemical reactor.

There is therefore an unmet need to provide improved capillary attachment to the inlets and outlets and improved filtration without impacting the maximum usable pressures.

Chemical reactors and methods described herein include a filter having support pillars and/or transition pillars located in a first duct and a transition region of the filter to improve pressure compliance. The first duct and transition region are portions of the filter where the fluid stream widens from the flow path width at the inlet to larger flow path width across the filter and separation or processing element. Because of the increasing width in the first duct and transition regions, void spans become large and the filter becomes more prone to failure (i.e., cracking, bowing of top or bottom plates, etc.) under application of fluid at high pressure. The support pillars and/or transition pillars reduce the maximum void span that can occur in the filter and thereby improves pressure compliance. Thus, chemical reactors and methods taught herein that are able to withstand greater pressure can enable improved fluidic processes, such as high-pressure liquid chromatography, and can provide higher throughput than conventional devices that have large void spans.

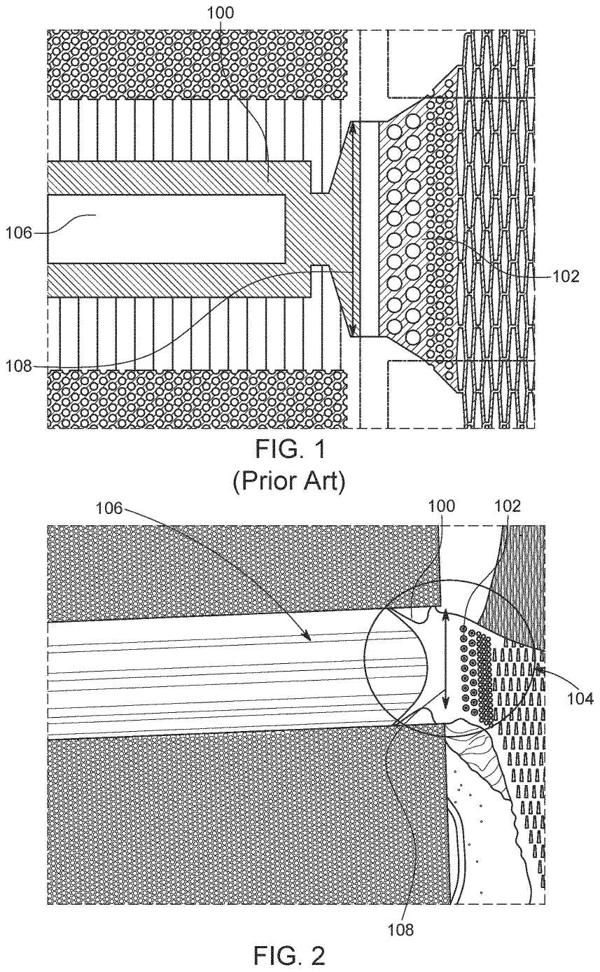

FIG. 1 shows a top-down view of a prior art arrangement of a chemical reactor implemented on a substrate. The chemical reactor is implemented on a flat semiconductor wafer where features such as channels and pillars are etched by wafer processing techniques such as Reactive Ion Etching (RIE). A cover, such as a borosilicate glass cover, is sealed to the tops of the features, which are not etched. This seals the reactor so that the interior can be placed under pressure relative to the exterior. A capillary 106 can be inserted and glued into a deep etch area 100 which is fluidly connected to a filter that is in a shallow etch area 102. The arrangement includes a large void span 108. Due to the large void span 108, the conventional chemical reactor of FIG. 1 can fail during processing of fluids at typical operating pressures. Failure modes can include bowing of the substrate or cover (leading to bursting or leakage) or cracking of the substrate, cover, channels, or pillars.

FIG. 2 shows the prior art arrangement in FIG. 1 after failure caused by application of fluid through the capillary at a pressure greater than the maximum compliance pressure of the device. Numerous tests showed that failure usually originates in the circled area 104 where the capillary 106 and the filter are connected. Without being bound to a specific theory, it was speculated that the reason for this failure is due to the large void span 108, where the top plate is not supported and, therefore, the brittle material bends and undergoes catastrophic failure.

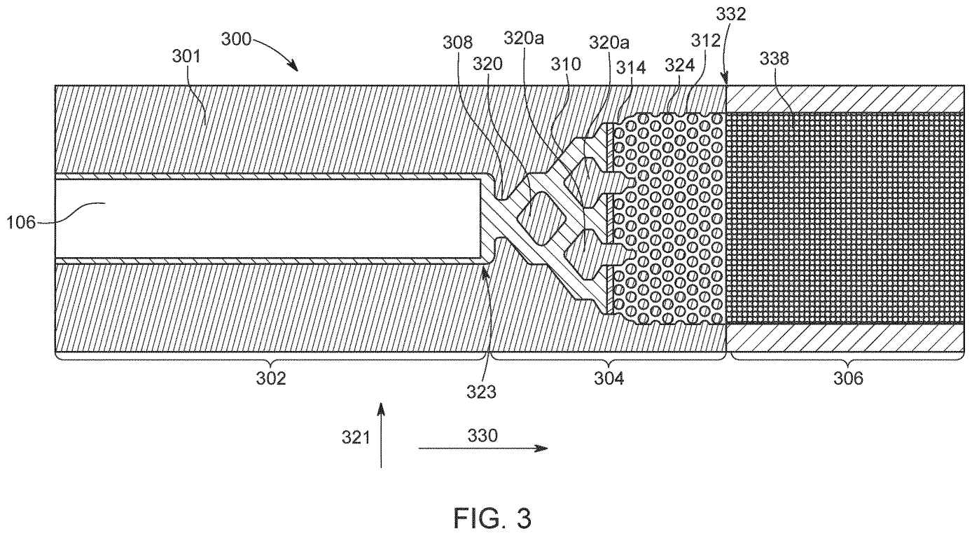

FIG. 3 is a top-down view of a chemical reactor 300 implemented on a substrate 301, according to some implementations. Features can be formed or etched in a direction perpendicular to the page so that lines shown in this top-down view define substantially vertical walls that define the features in the chemical reactor 300. Some methods of forming, such as RIE, provide almost vertical walls, although a slight widening of features towards the top, nearer to the origin of the ion beam, occurs. Other methods, such as casting from a mold, also require a narrowing towards the top to release the mold, although the scale or dimensions of the features are much larger. Other possible methods, such as mechanical milling or 3D printing can form more vertical walls, although the feature size is also larger than can be achieved with RIE. An average flow direction 330 for a fluid passing through the chemical reactor 300 is defined, as well as a perpendicular direction 321 to the average flow direction 330.

The chemical reactor 300 includes a filter 304 that is fluidly connected to an inlet 302 through a filter entrance 308 on the upstream side of the filter 304. The filter 304 is also fluidly connected to a separation or processing element 306 through a filter exit 332 on the downstream side of the filter 304. The filter 304 includes a first duct 310, a second duct 312, and a transition region 314 connecting the first duct 310 to the second duct 312. The capillary 106 can be inserted or positioned in the inlet 302 up to a stop 323, which is a narrowing of the deep etch area or barrier walls provided at the end of the inlet 302 proximate to the filter entrance 308. The capillary can be glued or otherwise sealed in place. In some embodiments, the first duct 310, second duct 323, or transition region 314 are defined by having a flow path or channel width that is distinct from the flow path or channel width of the other members of the set. For example, a width of the first duct 310 can be less than a width of the transition region 314. Likewise, the width of the transition region 314 can be less than a width of the second duct 323. In the filter 304 and the processing elements 306, the various channels, ducts or flow channel(s) can be subdivided and defined by pillar structures such as a support pillar 320, a transition pillar 320a, a filter pillar 324, and a processing pillar 338. For example, the support pillar 320 subdivides the first duct 310 from one upstream channel or duct into two downstream channels, which are further subdivided into three channels by the transition pillars 320a. The filter pillars 324 and processing pillars 338 divide and recombine flow paths through the second duct 312 and processing element 306, respectively, providing a tortuous path through the chemical reactor 300. In some implementations, the processing element 306 does not include any pillars.

The filter 304 traps debris in the fluidic stream before the fluid enters sections of the device with less interpillar distances. Debris and agglomeration are often present in the sample and cannot always be avoided, so filters 304 conventionally become clogged after some period of use. In conventional devices, the first duct 310 expanded in width to distribute the sample over a large number of filter pillars such that the fluid has many pathways and can route around clogs that may occur. However, the expansion of the first duct 310 creates a large void span that can compromise the pressure compliance of the device, e.g., the pressure of the fluid over an area with large void span can cause delamination or bursting of the device. Devices taught herein having transition pillars and support pillars still enable distribution of fluid over the full width of the section with filter pillars while also improving pressure compliance of the device as a whole.

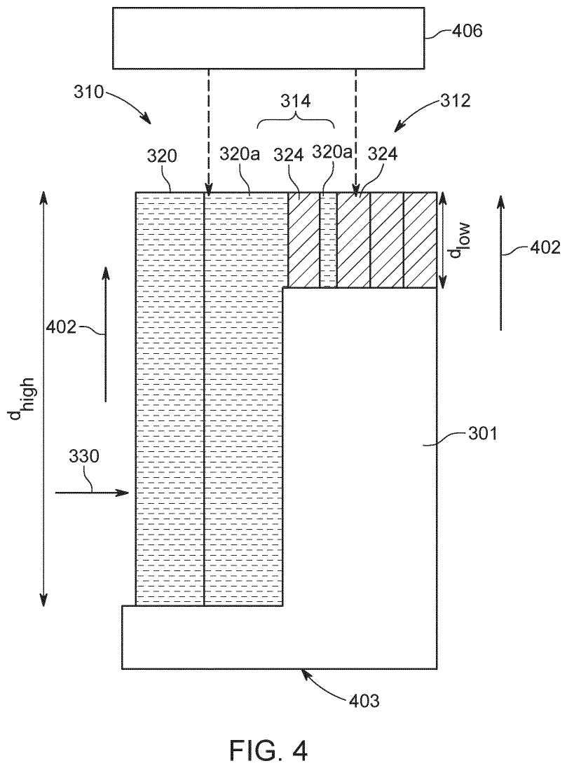

FIG. 4 is a side view showing details of the filter 304. The first duct 310 includes a first duct depth of dhigh in a depth direction 402. The inlet 302 shown in FIG. 3 also has an inlet depth of dhigh. The depth dhigh can be any depth commensurate with the manufacturing method. For example, when RIE is used, the depth dhigh can be between 1 μm and 1000 μm. In some implementations, dhigh is between about 3 μm and 200 μm, such as between 50 μm and 200 μm or 100 μm and 150 μm. The second duct 312 includes a second duct depth of dlow in the depth direction 402. The depth dlow can span the ranges described for dhigh, provided that dlow is less than dhigh. In some implementations, dlow is between 1 μm and 100 μm, such as between 3 μm and 80 μm or between 30 μm and 50 μm. The transition region 314 includes a transition depth of dhigh proximate to the first duct 310 and dlow proximate to the second duct 312. Thus, the transition region 314 provides a step change in the depth which transitions from dhigh, to accommodate a capillary in the inlet 302, and dlow which is the depth that can be used throughout the rest of the chemical reactor 300. The discussion here is limited for simplicity to examples with two different depths (e.g., produced by two lithographic operations each associated with a single depth). However, it will be appreciated that chemical reactors taught herein can include additional depths in different portions of the structure. For example, the inlet 302, filter 304, and processing elements 306 can each be etched or formed with different feature depths from one another in some examples. Additional subdivisions of the device or regions into different depth levels is also contemplated.

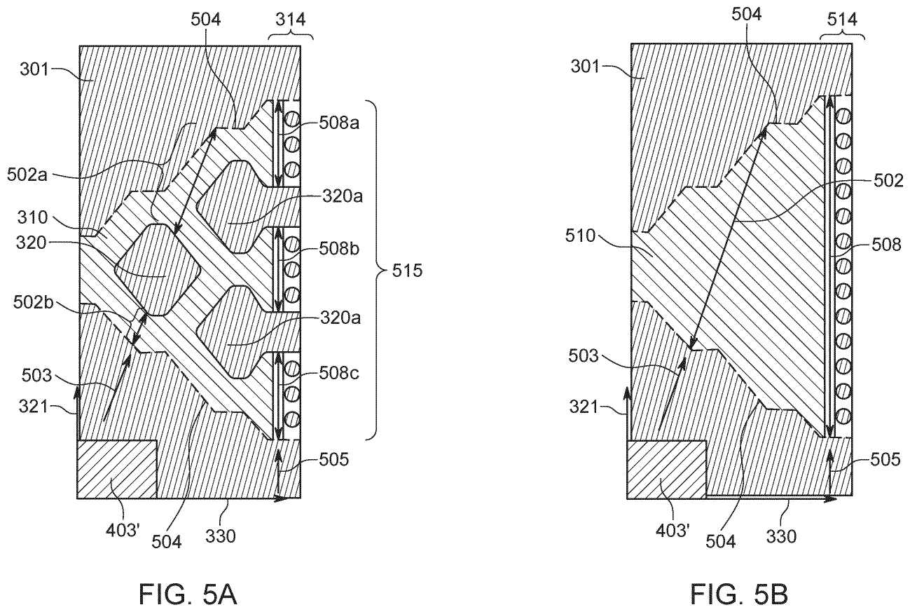

The substrate 301 has a bottom 403 which defines a plane containing the vectors defined by average flow direction 330 and the perpendicular direction 321 (FIG. 3). On the opposite end to the bottom 403, a cover 406 is positioned on the substrate 301 and contacts or is attached to the non-etched portions of the substrate 301 such as the top of the support pillars 320, the transition pillars 320a, the filter pillars 324, the separation pillars 338, and outer walls (see edges 504 in FIG. 5A that define the outer walls). In this way, the cover 406 seals the inlet 302, the filter 304, and the separation or processing element 306 on the top. In FIG. 4, the cover 406 is shown detached from the substrate 301 for clarity, where dashed arrows show how it can be placed.

The cover 406 can be made of any suitable material that can provide a seal to the top of the chemical reactor 300. The cover 406 and the substrate 301 can be selected for compatibility or suitability for sealing. In some implementations, the cover 406 is attached to the substrate 301 by bonding. The method of bonding depends on the materials used. For example, if the substrate 301 and cover 406 are plastic such as polycarbonate, acrylic, polydimethylsiloxane (PDMS), or polyethylene, an adhesive can be used. In the case of thermoplastic materials, melt bonding or a solvent bonding can be used. If the materials used are glass, such as silicate glass, then anodic bonding can be used. In some implementations, the cover 406 is attached to the substrate 301 by compression, such as by clamping or fastening (e.g., with screws) the cover 406 to the substrate 301. In some implementations, such as where the cover 406 and the substrate 301 are metal, clamping, gluing, or welding can be used.

In some implementations, the substrate 301 is a semiconductor wafer and the cover 406 includes a silicate glass, such as borosilicate, and the substrate 301 and cover 406 are anodically bonded to each other. While a semiconductor wafer, such as a silicon wafer, is a single crystal, surfaces form oxides and hydroxyl groups so that the interfaces act as a glass that can bond to a silicate glass cover 406. In some implementations, the cover 406 and/or the substrate 301 is constructed or formed as a uniform or homogenous material. In some implementations, the cover 406 and/or the substrate 301 does not include any reinforcing material in its bulk such as carbon fibers or rebar. In some implementations, the cover 406 and/or the substrate 301 is constructed or formed with brittle materials.

The support pillars 320 span the first duct 310 in the depth direction 402 (i.e., the support pillars 320 span the distance between the substrate 301 and the cover 406). The filter pillars 324 span the second duct 312 in the depth direction 402. The transition pillars 320a span the transition region 314 in the depth direction 402, as well as in the average flow direction 330. In some implementations, a pillar selected from the support pillars 320 or the transition pillars 320a at least partially overlaps in the perpendicular direction 321 (FIG. 3) with another pillar selected from the support pillars 320, the transition pillars 320a, or the filter pillars (324). An example of this overlap is shown in FIG. 3 between support pillar 320 and transition pillar 320a: if the support pillar 320 and transition pillar 320a did not overlap, a gap would be seen between these two pillars. In some implementations, there is at least a partial overlap between the transition pillars 320a and the filter pillars 324 in the perpendicular direction 321. In some implementations, there is also at least a partial overlap between different filter pillars 324 in the perpendicular direction 321. In some implementations there is also at least a partial overlap between different support pillars 320 in the perpendicular direction 321. In some implementations, the overlap in the perpendicular direction 321 is at least about 1% of the average pillar diameter (e.g., at least 10%). In some implementations, the overlap in the perpendicular direction 321 is less than about 90% of the average pillar diameter (e.g., less than about 50%). In some implementations, the overlap in the perpendicular direction 321 is at least 10 nm, such as at least about 100 nm. This overlap or interdigitation of the various pillars can increase the tortuosity of fluid flowing in the chemical reactor 300 and, as will be discussed below, reduces void volumes.

Some void spans are illustrated by FIGS. 5A and 5B. FIG. 5A shows a top-down view of the structure of the first duct 310 and a portion of the transition region 314 including the support pillar 320 and transition pillars 320a. FIG. 5B shows a top-down view of a comparative duct 510 and a comparative transition region 514 where the support pillars 320 and transition pillars 320a are not included. As used herein, “void span” refers to a total distance, in a direction parallel to the bottom 403 (or a plane 403′ defined by the flow direction 330 and the perpendicular direction 321), where the substrate 301 has been etched between the outer walls in any channels in the chemical reactor 300. In other words, a length of the void span is defined as the sum of the lengths of all segments of a line drawn parallel to the bottom 403 where the substrate 301 has been etched (i.e., the total length of the line minus the lengths of segments where the substrate 301 has not been etched). The length of the void span can alternatively be defined as the sum of the lengths of all segments of a line drawn parallel to the bottom 403 that overlie portions of the substrate 301 through which fluid flows. A “segment of a void span” (which may also constitute the entire void span in some configurations) can refer to the distance in a straight line of a path between two solid objects, where the path does not pass through a solid object. Devices and methods taught herein improve upon conventional microfluidic devices by including void-span reducing structures (such as support pillars 320 and transition pillars 320a) that help to enforce upper limits on the maximum void span length in the chemical reactor 300.

The edges 504 of outer walls are emphasized by dashed lines in the figures, and the dimensions of the edges 504 are identical in the two figures. A first direction 503 and a second direction 505, both parallel to the bottom 403, are shown in both figures. FIGS. 5A and 5B illustrate the differences in void span that are obtained in structures with and without void-span reducing structures such as support pillars 320 and transition pillars 320a. For example, a first void span, which is the sum of 502a and 502b as shown in FIG. 5A, is smaller than a second void span 502 shown in FIG. 5B (i.e., without the support pillars) where both first and second void spans are measured along the same direction (first direction 503). As another example, a third void span shown in FIG. 5A, which is the sum of 508a, 508b and 508c, is smaller than a fourth void span 508 shown in FIG. 5B (i.e., without the transition pillars 320a) where both third and fourth void spans are measured along the second direction 505. This shows how, in the first duct 310, the support pillars 320 can be configured to provide a first void span, 502a+502b, measured in the first direction 503 parallel to the bottom 403 of the substrate 301, that is smaller than a second void span 502 measured in the same first direction 503 but without the support pillars 320. This also shows how, in the transition region 314, the transition pillars 320a can be configured to provide a third void span, 508a+508b+508c, measured in the second direction 505 parallel to the bottom 403 of the substrate 301, that is smaller than the fourth void span 508 in the same second direction 505 at the comparative transition region 513, without the transition pillars 320a. In some examples, the filter expands from a smaller inlet width to match a larger overall entrance width 515 of the second duct 312 (e.g., the distance between outer walls in the second duct). At the same time, the individual segments of the void span are significantly shorter than the overall entrance width 515 as defined by the edges 504 of the outer walls or by a width of the filter region including filter pillars. In various examples, the length of each segment of the first void span (502a+502b) or the third void span (508a+508b+508c) is in a range of 0.2 to 0.5 times the overall entrance width 515 of the second duct 312.

Although the edges 504 in FIGS. 5A and 5B are identical between the figures, the resulting first duct 510 including support pillars 320 and transition pillars 320a will have a lower flow rate under the same pressure conditions than the structure in FIG. 5B because the presence of the pillars reduces the total flow volume available. However, it may be desirable to replace a pre-existing conventional chemical reactor device with an improved chemical reactor device as taught herein such that the same flow rate is maintained under the same pressure conditions for the same setup. In such a case, the edges 504 of the outer walls can be designed as being spaced further apart to increase the total overall entrance width 515 of the chemical reactor 100. For example, the overall entrance width 515 (and void span) of the conventional device can be 75 μm, and the overall entrance width 515 of the replacement chemical reactor 100 can be 95 μm. For example, the overall entrance width 515 of the reactor 100 can be three 25-μm-long segments of the void span 508a, 508b, 508c and two 10-μm-long portions of the transition pillars (25+25+25+10+10=95 μm). Thus, the total length of the void span (75 μm) of the newly designed device is about the same as the original void span of the replaced conventional device such that the same flow rate in the system can be maintained. However, the additional benefit of significantly increased pressure compliance is achieved. Thus, the chemical reactor device can be designed such that total flow through the transition region is not significantly reduced as compared to a pre-existing chemical reactor, yet the pressure compliance of the chemical reactor is increased. In some examples, the chemical reactor device taught herein including support pillars and/or transition pillars that create a segmented void span can have a pressure compliance (i.e., maximum pressure the device can withstand before failure) that is at least 10%, at least 20%, at least 30%, at least 50%, at least 75%, or at least 100% greater than the pressure compliance of a device with comparable total void span in a single segment.

In some implementations, a ratio of the first void span (i.e., the sum of 502a and 502b) to the second void span (502), is less than 0.9. In some implementations, a ratio of the third void span (i.e., the sum of 508a, 508b, and 508c) to the fourth void span (508) is less than 0.9 (e.g., less than 0.8, less than 0.7, less than 0.6, or less than 0.5). Without being bound to a specific theory, it is speculated that the support pillars 320 and transition pillars 320a, by reducing the void span as compared to structures without the pillars, provides a structure that can withstand higher pressures.

In some implementations, the support pillar 320 or transition pillars 320a each have an average diameter greater than an average diameter of the filter pillars 324. In some implementations, the support pillar 320 or the transition pillars 320a each have an average diameter at least two times the average diameter of the filter pillars 324. In some implementations, the support pillar 320 or transition pillars 320a each have an average diameter at least five times the average diameter of the filter pillars 324. The average diameter can be calculated using equations for a circle where the area of the pillar (i.e., the cross-sectional area or the area of the top of the pillar as see in FIG. 3) is substituted for the area of a circle. That is:

$$d = 2 \sqrt{\frac{A}{π}} ;$$

where d is the average diameter and A is the area of the top of the pillar.

In some implementations, the support pillar 320 or the transition pillars 320a each have a volume that is larger than the volume of each of the individual filter pillars 324. The transition pillars 320a and support pillars 320 are located at least partially in a region of the first duct 310 where the channel depth is deeply etched to accommodate the capillary. As a result, the linear dimensions, area, and/or volume of the support pillars 320 and transition pillars 320a tend to be greater than those of filter pillars 324 to ensure that the pillars can be reliably defined by the etch process (wherein etching narrow, deep structures is challenging). Larger support or transition pillars can also improve mechanical support strength for the device. In some implementations, the support pillar 320 or the transition pillars 320a each have a volume at least 4 times the volume of each of the filter pillars 324. In some implementations, the support pillar 320 or the transition pillars 320a each have a volume at least 25 times the volume of each of the filter pillars 324. The interpillar distances between support pillars 320 and transition pillars 320a (support to support, transition to transition, or support to transition) are generally larger than distances between filter pillars 324 to enable high flow rates and prevent channel blockages (particularly because the number of passages in this region is small and blockages would have a disproportionately negative effect).

The specific dimensions of the support pillars 320, the transition pillars 320a, and filter pillars 324 depend in part on the purpose and overall size of the chemical reactor 300. For example, in some implementations, the filter pillars 324 are in the millimeter range (e.g., 0.1 mm to 10 mm) while in other implementations, the filter pillars are in the micrometer range (e.g., 0.1 to 10 μm). The distances between the filter pillars also depends in part on the purpose and overall size of the chemical reactor 300. In some implementations, the minimum distance between adjacent filter pillars is less than or equal to the average diameters of the pillars. In some implementations, the minimum distance between the support pillars 320 and transition pillars 320a, or between adjacent support pillars 320, or between adjacent transition pillars 320a is between about 5 and 20 μm. In some implementations, the minimum distance between adjacent filter pillars 324 is between about 0.5 μm and about 5 μm. In some implementations, the minimum distance between adjacent transition pillars 320a and filter pillars 324 is between about 0.5 μm and 5 μm. In some implementations, the second duct 312 can include a transitions between different minimum interpillar distances or diameters of pillars such that different combinations of interpillar distances and/or pillar diameters are achieved.

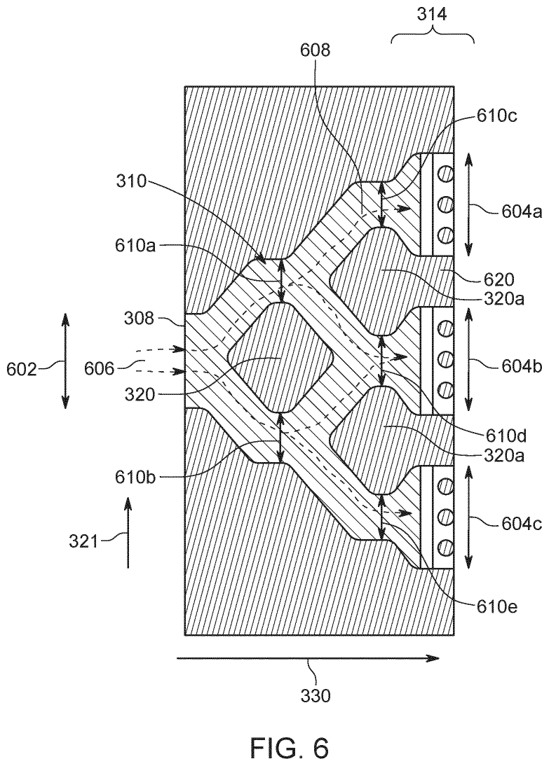

FIG. 6 is top-down view of the first duct 310 and a portion of the transition region 314 as shown in FIG. 5A. An input void span 602 is the shortest void span including the filter entrance 308 and is proximate to the inlet 302 (FIG. 3). The output void span made up of segments 604a, 604b, and 604c is in the transition region 314 and is located distally from the inlet 302. The support pillar 320 and transition pillars 320a furcate a flow 606 from a single path into a furcated flow path 608 between the filter entrance 308 and the filter exit 332 (FIG. 3). In some implementations, a path width of a furcated flow path, such as 610a, 610b, 610c, 610d, and 610e, as measured perpendicular to the direction of flow in the furcated flow path 608, is substantially equal throughout the furcated flow path 608. For example, the furcated flow path widths can all be within 10% of each other in some examples. In some implementations, the path width of the furcated flow path, such as 610a, 610b, 610c, 610d, and 610e, is less than the input void span 602. For example, the path widths 610a, 610b, 610c, 610d, and 610e of the furcated flow path 608 can be about 50% of the input void span 602 in some examples. In some implementations, the input void span 602 is equal to or smaller than each segment 604a, 604b, 604c of the output void span. In some implementations, the output void span (for example, 604a+604b+604c) can be made as large as possible to provide a maximum flow through area or volume. In other examples, the length of the output void span 604a, 604b, 604c along direction 321 is not maximized so as to balance other parameters such as the diameter, shape, or size of transition pillars 320a to enable compliance with application of desired fluidic pressures.

The shape and orientation of the support pillars 320 and the transition pillars 320a, can be selected at least in part to provide the desired parameters for the furcated flow path 608. For example, a diamond shape cross section profile with rounded edges or points is shown for the support pillars 320 in FIGS. 3, 5A, and 6. Shapes can be selected with increased roundedness of one or more points (i.e., more blunted points) in which case these points become flatter and act more like additional sides of the pillar. Thus, the support pillars 320 can be described as having a diamond shaped cross-section profile, a hexagonal shaped cross-section profile, an octagonal shaped cross-section profile, or other polynomial shaped cross-sectional profile. The transition pillars 320a can have the same diamond shape as the support pillars 320 but with the additional inclusion of a protrusion 620 into the transition region 314 to reduce the output void span 604a, 604b, 604c in the transition region. The support pillar 320 and transition pillars 320a can be oriented the same way, that is, with two opposite points aligned in the flow direction 330, and two remaining opposite points aligned to the perpendicular direction 321. The orientation and shape of support pillar 320 and transition pillars 320a can be selected to minimize large variations in the path width of the furcated flow path 608. Additionally, the shape and orientation of the support pillars 320 and transition pillars 320a can be selected to create short sections of straight channel (e.g., sections parallel to flow direction 330) such as the sections labeled as 610a and 610b. As fluid leaves these sections, the fluid approaches the next pillar head-on and is incentivized to bifurcate around the pillar (i.e., probability of flowing around the pillar in either direction is about equal).

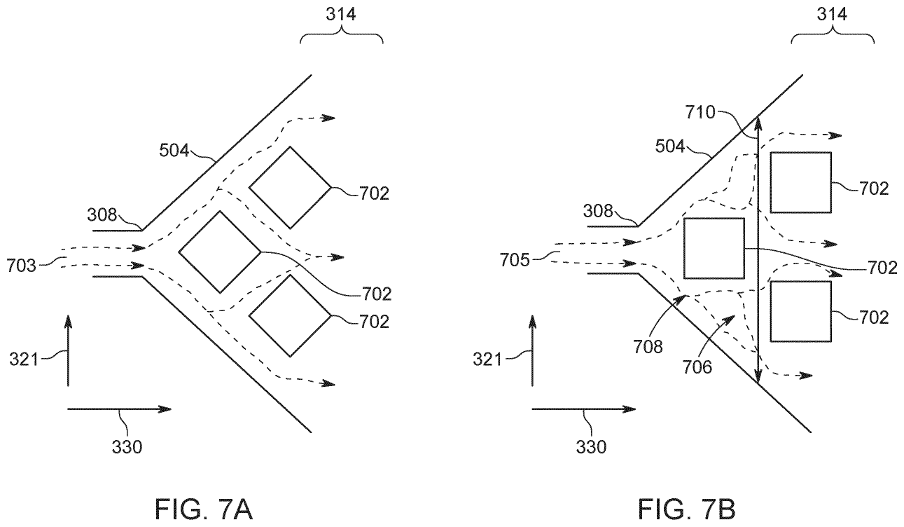

FIGS. 7A and 7B show another example of pillar shape and orientation, according to some implementations. In these top-down views, the filter entrance 308, edges 504 of outer walls, the transition region 314, the flow direction 330, and the perpendicular direction 321 are indicated for orientation. FIG. 7A includes square support pillars 702 which are oriented in the same way as the support pillars 320 shown in FIG. 6. The square support pillars 702 differ from the rounded diamond support pillars 320 by including sharply defined corners. In addition, the orientation of square support pillars 702 does not create short sections of straight channel as in FIG. 6, and fluid is not incentivized to flow equally around subsequently encountered pillars as the design creates low resistance to flow continuing along the outer walls 504. The square support pillars 702 in FIG. 7A overlap one another along the direction the perpendicular direction 321, i.e., in a region bounded by the first, upstream support pillar and the last, downstream support pillar, no line can be drawn along perpendicular direction 321 without intersecting at least one support pillar. In the implementation shown in FIG. 7B, the square support pillars 702 are oriented differently such that fluid flow entering from the inlet 308 first encounters a sidewall of the square support pillar 702 rather than a corner or point of the square support pillar 702. The uniformity of the width of a flow path can be affected by the choice of pillar shape and orientation. For example, segments of a flow path 703 through the square support pillars 702 as illustrated in FIG. 7A have a relatively uniform width throughout the entire flow path 703. Conversely, segments of a flow path 705 through square support pillars 702 arranged as shown in FIG. 7B can vary in width. For example, areas having large widths 706 and areas with smaller widths 708 occur in the flow path 705 shown in FIG. 7B. In the orientation of the square support pillars 702 shown in FIG. 7B, a larger void span 710 occurs where the square pillars 702 do not at least partially overlap in the perpendicular direction 321.

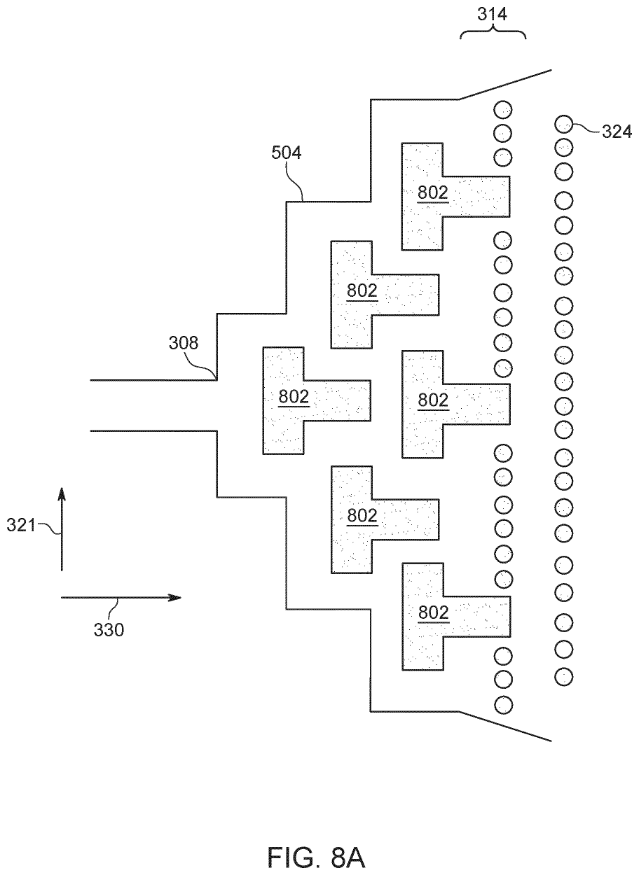

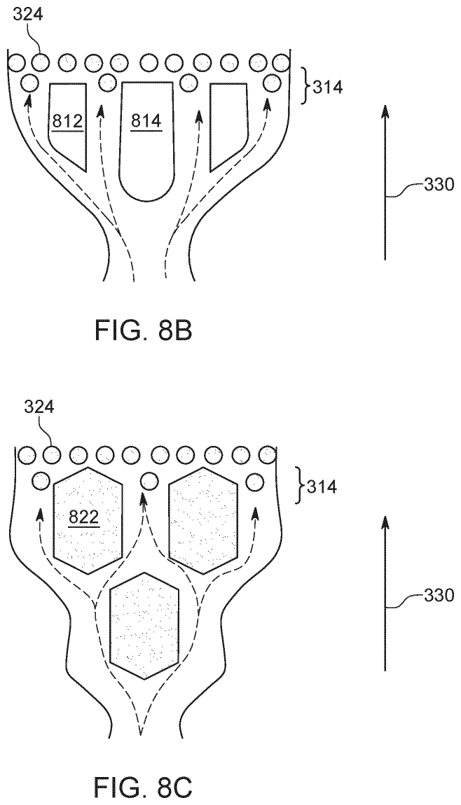

FIGS. 8A, 8B and 8C show other designs for chemical reactors, according to some implementations. FIG. 8A shows a design for a chemical reactor including T-shaped support pillars 802. The view is a top-down view where the filter entrance 308, edges 504 of outer walls, the transition region 314, the filter pillars 324, the flow direction 330, and the perpendicular direction 321 are indicated for orientation. The use of T-shaped support pillars 802 reduces the void span in the perpendicular direction 321 throughout the first duct and transition region 314 as compared to a structure without the T-shaped support pillars 802 and provides substantially constant and equal width flow paths around the T-shapes 802. As with other designs taught in this application, the design using T-shaped support pillars 802 also increases the amount of overlap between support pillars 320 in a direction perpendicular to the flow direction (i.e., analogous to direction 321 in FIG. 3) while ensuring uniform, high flow rates and distributing fluid flow towards the widening transition region.

In some examples, different sizes and/or shapes of support pillar can be employed in a single chemical reactor. FIG. 8B shows large pillars 812 and 814, before filter pillars 324 as well as the transition region. In accordance with some examples such as that of FIG. 8B, the first duct and/or transition region of the chemical reactor can include symmetric placement of support pillars (e.g., pillars 812 and 814) across a center line along the flow direction 330 and equidistant from the edges 504 of the outer walls of the device. FIG. 8C shows large pillars 822 that have an elongated hexagonal structure. The elongation is in the flow direction 330. The filter pillars 324 and transition region are also indicated.

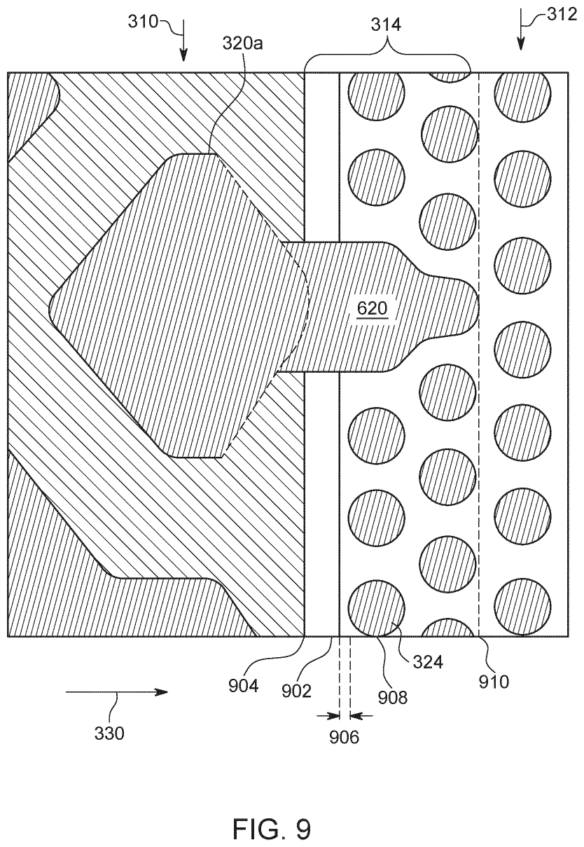

FIG. 9 illustrates another feature according to some implementations. The figure is a top-down detailed view showing the transition region 314 between the first duct 310, and the second duct 312. A first transition edge 902 indicates the transition from a depth of dhigh to dlow. A second transition edge 904 is also shown, which defines an upstream boundary of the transition region 314. The area between the first transition edge 902 and the second transition edge 904 is where an overlap of a deep etch and a shallow etch occurs. Use of the overlap area can help to avoid issues during RIE due to alignment accuracy limitations. For example, in the absence of the overlap and absent perfect alignment, substrate material can remain (i.e., may not be fully etched) which can obstruct the flow of fluid. In some implementations, an overlap length, or distance between the first transition edge 902 and the second transition edge 904 in the flow direction 330, is in a range between 5 μm and 10 μm.

In addition to overlap, an offset 906 between the first transition edge 902 and a nearest approach of filter pillars in a first row 908 of the filter pillars 324 can be implemented. Use of the offset 906 can avoid accidental etching of the filter pillars 324 during formation of the deeper first duct due to alignment accuracy limitations. The transition region 314 has a downstream boundary 910 shown by a dashed line. The downstream boundary 910 is aligned with the downstream end of the protrusion 620. A dashed line shown on the transition pillar 320a indicates the approximate shape of the transition pillar 320a if the protrusion 620 is not included, which would provide a shape similar to the support pillars 320. In this implementation, the protrusion 620 spans the transition region 314 in the flow direction 330. The protrusion 620 therefore provides a reduced void span in a direction perpendicular to the flow direction 330 in the transition region 314. In some implementations, the offset 906 is less than 5 μm, such as between about 1 μm and 3 μm.

In some implementations, the filter pillars 324 are not provided between the first transition edge 902 and the downstream boundary 910. In such an implementation, the transition pillar 320a provides support and reduces the void span in a direction perpendicular to the flow direction 330 in the transition region 314. However, a benefit of including the filter pillars 324 in an area between the first transition edge 902 and the downstream boundary 910 is providing an initial filter barrier close to where the transition from dhigh and dlow occurs. As has been previously reported, the transition from a deep etch area to a lesser (i.e., shallower) etch can provide a filtering effect where debris may collect in the deep etch area. It is suggested that without the filter pillars close to the transition edge 902, large agglomerates could pack into the transition region where the depth transitions from dhigh to dlow and thus block fluid flow.

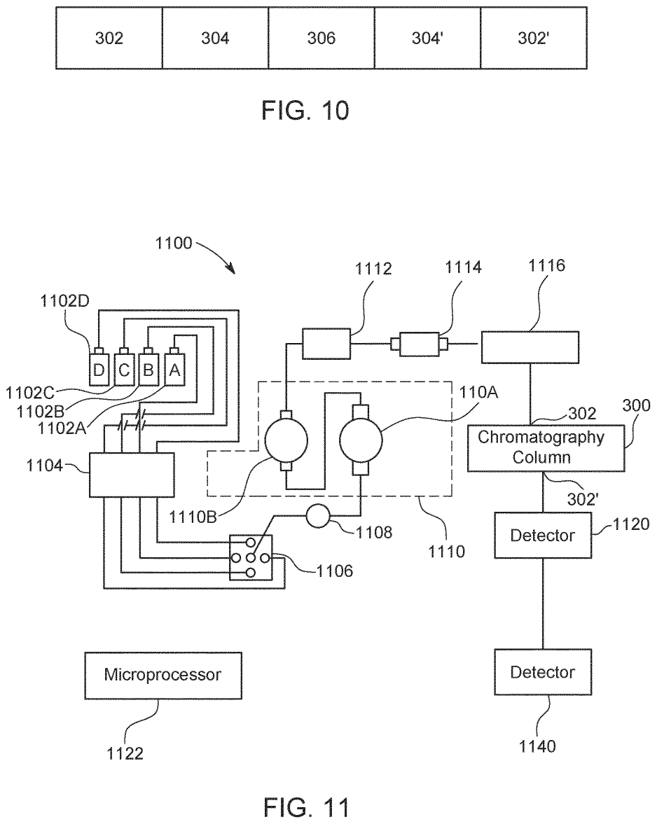

Implementations have been described as relating to an inlet end of the chemical reactor 300, where the flow direction 330 is from the inlet 302 to the separation or processing element 306. However, in some implementations the flow can be reversed. That is the chemical reactor can be operated in a direction that is negative from the flow direction 330 such that the inlet 302 can be an outlet. In some implementations, an arrangement as shown by FIG. 10 can be made. This figure shows elements as blocks. The structure is substantially symmetric about the separation or processing element 306 so that a first end includes the inlet 302 and filter 304 connected to the separation or processing element 306 and a second end includes a second filter 304′ (connected to the separation or processing element 306) and a second inlet 302′ connected to the second filter 304′. In some implementations, the first inlet 302 and second inlet 302′ are geometrically equivalent structures such that they are superimposable or are mirror images. In operation, the second inlet 302′ can act as an outlet when fluid is added through the first inlet 302, and the first inlet 302 can act as an outlet when fluid is added through the second inlet 302′. In some implementations, 302 and 302′ are functionally equivalent such that they are inlets or outlets but can have, for example, different diameters. In some implementations, the first filter 304 and the second filter 304′ are geometrically equivalent, while in other implementations, the first filter 304 and second filter 304′ are functionally equivalent such that they both provide filtering but have, for example, different sizes, shapes, and/or geometries of support pillars, transition pillars, or filter pillars.

In some implementations, the chemical reactor 300 is a chromatography column. FIG. 11 is a schematic of a chromatography system 1100, according to some implementations. Chromatography system 1100 can include mobile phase reservoirs, such as the four mobile phase reservoirs (1102A, 1102B, 1102C, 1102D), an optional degas assembly 1104, an eluent proportioning valve assembly 1106, a tubing assembly 1108, a pump 1110 having a primary pump head 110A and a secondary pump head 1110B, a pressure transducer 1112, a gradient mixer 1114, an injection valve 1116, the chemical reactor 300 (configured here as a chromatography column), a first detector 1120, optionally a second detector 1140, and a microprocessor 1122. In some implementations, one of the detectors is a mass spectrometer, where if two detectors are used, the MS is the downstream detector. In some implementations, a t-connection (not shown) leads from the chemical reactor 300 and splits an output 302′ with a first branch connected to the first detector 1120, and a second branch leading to the second detector 1140.

The inlet 302 is downstream from the injection valve 1116, and the output 302′ is upstream of the detectors 1120, 1140. The operation of components other than the chemical reactor 300 are well known and are not described in detail here but are provided to illustrate an embodiment of the possible use of the chemical reactor 300. In some implementations, the chemical reactor 300 can withstand pressures above 500 bar, such as above about 750 bar. This provides a column with excellent throughput.

An analyte can be separated from a mixture in solution using the chromatography system 1100. The mixture containing the analyte is injected into the injection valve 1116 and carried through the chemical reactor by a mobile phase provided by one or more of the mobile phase reservoirs such as 1102A, 1102B, 1102C, and 1102D. The analyte is separated from other components in the mixture and detected by one or more of the detectors 1120, 1140.

The following numbered paragraphs provide various examples of the embodiments disclosed herein.
Paragraph 1. A chemical reactor (300) implemented on a substrate (301), the chemical reactor (300) comprising: an inlet (302) including an inlet depth; a filter (304) fluidly connected to the inlet (302) through a filter entrance (308) and including; a first duct (310) including a first duct depth of dhigh and one or more support pillars (320) spanning the first duct (310) in a depth direction (402), a second duct (312) including a second duct depth of dlow and filter pillars (324) spanning the second duct 312 in the depth direction (402), and a transition region (314) connecting the first duct (310) to the second duct (312), the transition region (314) including a transition dept of dhigh proximate to the first duct (310) and dlow proximate to the second duct (312), and a transition pillar (320a) spanning the transition region (314) in depth direction (402) as well as in an average flow direction (330); and a separation or processing element (306) fluidly connected to the filter (304) through a filter exit (332).
Paragraph 2. The chemical reactor according to paragraph 1, wherein; the support pillars (320) are configured to provide a first void span (the sum of 502a and 502b) measured in a first direction (503) parallel to a bottom (403) of the substrate (301) that is smaller than a second void span (502) in the first direction (503) without the support pillars (320), and the transition pillars (320a) are configured to provide a third void span (508a, 508b, 508c) measured in a second direction (505) that is parallel to the bottom (403) that is smaller than a fourth void span (508) measured in the second direction (505) without the transition pillars (320a).
Paragraph 3. The chemical reactor according to paragraph 2, wherein a ratio of the first void span (502a, 502b) to the second void span (502) is less than 0.9, and a ratio of the third void span (508a, 508b, 508c) to the fourth void span (508) is less than 0.9.
Paragraph 4. The chemical reactor according to any of paragraphs 1-3, wherein a pillar selected from the support pillars (320) or the transition pillar (320a) at least partially overlaps in a perpendicular direction (321) to a fluid flow direction (330) with another pillar selected from the support pillars (320), the transition pillar (320a), or the filter pillars (324).
Paragraph 5. The chemical reactor according to any of paragraphs 1-4, wherein the support pillars (320) have an average diameter greater than an average diameter of the filter pillars (324).
Paragraph 6. The chemical reactor according to any of paragraphs 1-5, wherein an input void span (602) proximate to the inlet (302) is smaller than or equal to each segment of an output void span (604a, 604b, 604c) in the transition region (314).
Paragraph 7. The chemical reactor according to any of paragraphs 1-6, wherein the support pillars (320) furcate a flow (606) into a furcated flow path (608) between the filter entrance (308) and a first transition edge (902), wherein the transition edge (902) is located in the transition region (314) where a step from a depth of dhigh to dlow occurs.
Paragraph 8. The chemical reactor according to paragraph 7, wherein a furcated path width (610a, 610b, 610c, 610d, and 610e) perpendicular to the furcated flow path (608) is substantially equal throughout the furcated flow path (608).
Paragraph 9. The chemical reactor according to paragraph 7 or paragraph 8, wherein the furcated path width (610a, 610b, 610c, 610d, and 610e) is substantially equal to an input void span (602).
Paragraph 10. The chemical reactor according to any of paragraphs 1-9, wherein the inlet depth is dhigh in the depth direction.
Paragraph 11. The chemical reactor according to any of paragraphs 1-10, wherein the separation or processing element (306) includes separation or processing pillars (338).
Paragraph 12. The chemical reactor according to any of paragraphs 1-11 further comprising an offset (906) between a first transition edge (902) and the filter pillars (324).
Paragraph 13. The chemical reactor according to any of paragraphs 1-12, wherein the support pillars (320) in the first duct (310) have a diamond, hexagonal, or octagonal shaped cross-sectional profile with rounded points.
Paragraph 14. The chemical reactor according to any of paragraphs 1-13 further comprising a cover (406) sealing the inlet (302), the filter (304), and the separation or processing element (306), thereby allowing a fluid to flow through the chemical reactor under pressure.
Paragraphs 15. The chemical reactor according to paragraph 14, wherein the substrate (301) is a semiconductor wafer and the cover (406) is a silicate glass.
Paragraph 16. The chemical reactor according to any of paragraphs 1-15, wherein dhigh is between 1 and 1000 μm.
Paragraph 17. The chemical reactor according to any of paragraphs 1-16, further comprising a capillary (106) sealed in the inlet (302) up to a stop (323).

Paragraph 18. The chemical reactor according to any of paragraphs 1-19, wherein the structure is substantially symmetric about the separation or processing element (306) so that a first end includes the inlet (302) and filter (304) connected to the separation or processing element (306) and a second end includes a second filter (304′) connected to the separation or processing element (306) and a second inlet (302′) connected to the second filter (304′).

Paragraph 19. The chemical reactor according to any one of claims 1-18, wherein the support pillars and transition pillar provide a first void span (502a, 502b) measured in a first direction (503) parallel to a bottom (403) of the substrate (301) such that a length of each segment of the first void span is in a range of 0.2 to 0.5 times an overall entrance width (515) of the second duct.

Paragraph 20. The chemical reactor according to any one of claims 1-19, wherein the transition pillars (320a) are configured to provide a third void span (508a, 508b, 508c) including multiple segments measured in a second direction (505) that is parallel to the bottom (403), and wherein a pressure compliance of the reactor is at least 10%, at least 20%, at least 30%, at least 50%, at least 75%, or at least 100% greater than a pressure compliance of a reactor having a comparable single-segment void span.

Paragraph 21. A chromatography system including the chemical reactor 300 according to any one of paragraphs 1 to 20.

Paragraph 22. A method of separating an analyte from a mixture, the method comprising injecting the mixture containing the analyte into an injection valve 1116 of the chromatography system of paragraph 21.

### EXEMPLIFICATION

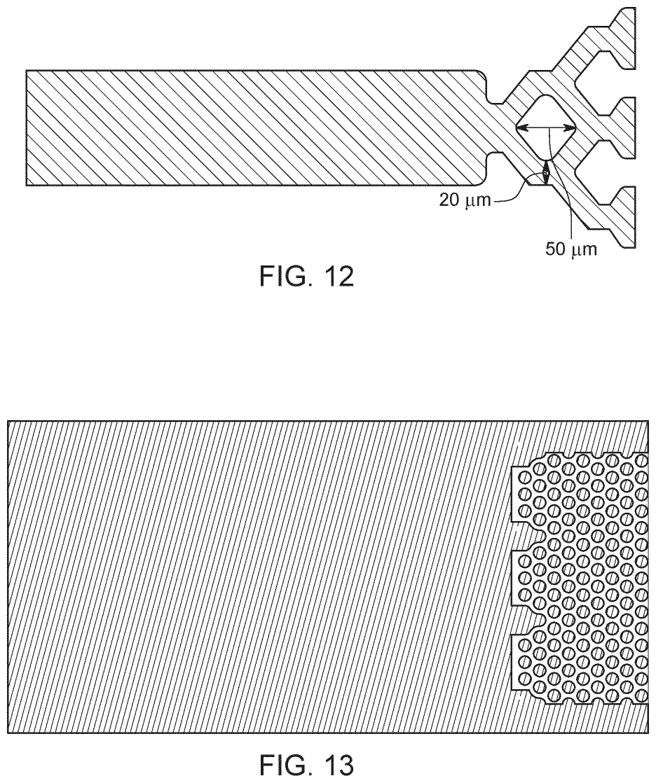

FIGS. 12-14 illustrate production steps for an example chemical reactor according to examples taught herein. The shaded area in FIG. 12 illustrates a first mask for an area that will undergo deep etching. A 675 μm thick 6-inch silicon wafer was subjected to RIE to a depth of 110 μm. This deep etch defined an inlet (i.e., at the depth dhigh) and part of a filter including a first duct. The example mask creates a first duct with large support pillars and transition pillars as indicated by arrows. The support pillars and the portion of the transition pillars outside the protrusion have a diamond-like structure with a diameter of 50 μm, as measured from one tip to another. The widths of the flow paths around the support pillars are about 20 μm, and the outlets of the first duct (i.e., into the transition region) have widths of about 50 μm.

The shaded area in FIG. 13 illustrates a second mask for an area that will undergo shallow etching. The substrate (wafer) was subjected to shallow RIE to a depth of 20 μm using the second mask. This shallow etch formed a second (downstream) part of a filter including cylindrical filter pillars each having a diameter of 10 μm. The filter pillars were spaced 5 μm apart. The shallow etch also provides protrusion structures indicated by the arrows that are integrated with some of the large diamond like structures formed in the deep etch. The second mask can be aligned to features formed by the first mask during production such that the protrusions in the second mask overlie the protrusions in transition pillars formed by the first mask.

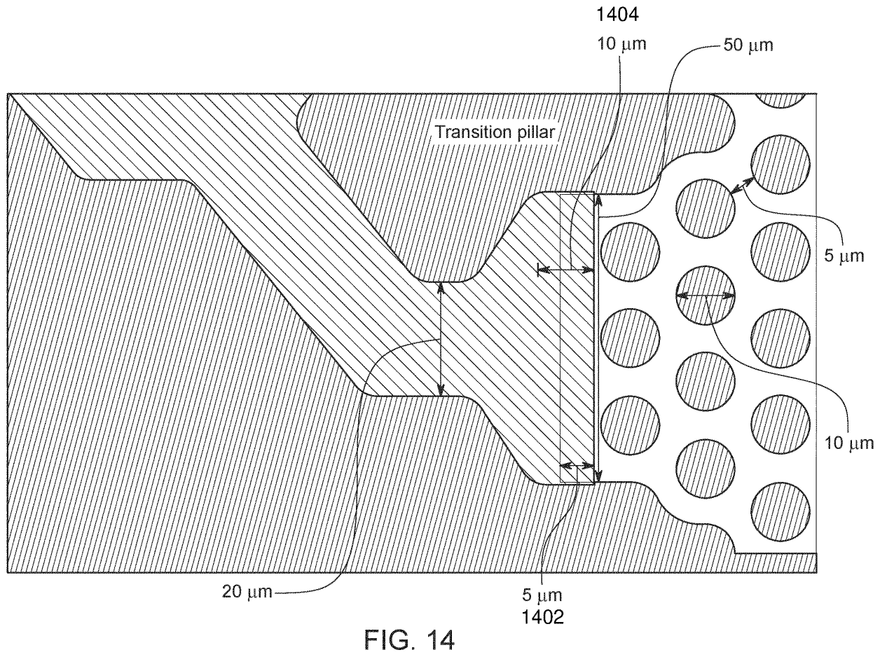

FIG. 14 shows a detail of part of the first duct and transition region formed from production using the first mask and the second mask. An overlap distance 1402 of the shallow and deep etch is about 5 μm wide. A tolerance distance 1404 can define a maximum offset between mask sets used sequentially for defining the separation bed and the deep etch (that creates structures that accommodate the capillary, for example). When the masks are aligned within the tolerance distance 1404, they are aligned to cover the appropriate regions and avoid gaps that might lead to incorrectly etched areas. In some examples, the tolerance distance 1404 is about 10 μm. In some examples, the tolerance distance 1404 is defined as a value in the range of (5 μm+the etching instrument's alignment accuracy) up to 50 μm.

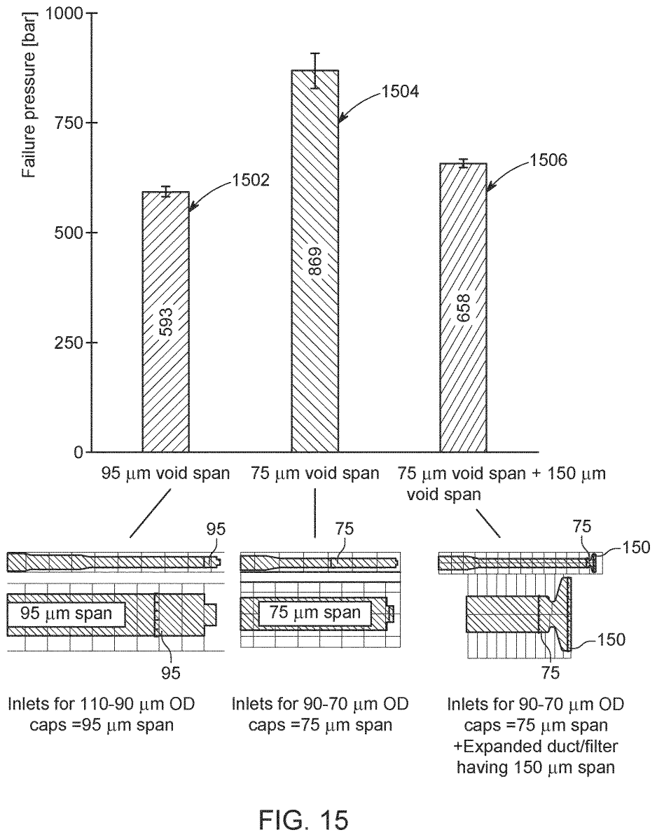

FIG. 15 is a bar graph showing pressure compliance (i.e., pressure at which the structure fails) of various structures including chemical reactors as taught herein. In a conventional chemical reactor that does not include support pillars 320 or transition pillars 320a, the void span can be as high as 95 μm. For such structures (bar 1502), the average failure pressure is 593 bar. In a similar conventional chemical reactor having no support pillars or transition pillars and having a void span of 75 μm (bar 1504), the failure pressure is an average of 869 bar. In a conventional chemical reactor including an expanding first duct and filter but no support pillars or transition pillars (bar 1506), as depicted in FIG. 1 (prior art), with an inlet void span of 75 μm and a maximum void span (in the filter) of 150 μm, the average failure pressure is 658 bar. Thus, the reduction of void spans in general can improve pressure compliance (i.e., from bar 1502 to 1504) whereas introduction of the expanded first duct and introduction of a filter region in a conventional device can lead to a loss of pressure compliance (i.e., from bar 1504 to 1506). Devices and methods taught herein can improve pressure compliance by reducing void span within the device. For example, including one or more support pillars 320 or transition pillars 320a in a chemical reactor increases the failure pressure to a value greater than 658 bar.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above implementation and examples but is encompassed by the following claims. All publications and patent applications cited above are incorporated by reference in their entirety for all purposes to the same extent as if each individual publication or patent application were specifically and individually indicated to be so incorporated by reference.

1. A chemical reactor implemented on a substrate, the chemical reactor comprising:
an inlet including an inlet depth;
a filter fluidly connected to the inlet through a filter entrance and including;
a first duct including a first duct depth of d_{high} and one or more support pillars spanning the first duct in a depth direction,
a second duct including a second duct depth of d_{low} and filter pillars spanning the second duct in the depth direction, and
a transition region connecting the first duct to the second duct, the transition region including a transition depth of d_{high} proximate to the first duct and d_{low} proximate to the second duct, and a transition pillar spanning the transition region in the depth direction as well as in an average flow direction; and
a separation or processing element fluidly connected to the filter through a filter exit.

2. The chemical reactor according to claim 1, wherein;
the support pillars are configured to provide a first void span measured in a first direction parallel to a bottom of the substrate that is smaller than a second void span in the first direction without the support pillars; and
the transition pillars are configured to provide a third void span measured in a second direction that is parallel to the bottom that is smaller than a fourth void span measured in the second direction without the transition pillars.

3. The chemical reactor according to claim 2, wherein a ratio of the first void span to the second void span is less than 0.9, and a ratio of the third void span to the fourth void span is less than 0.9.

4. The chemical reactor according to claim 1, wherein a pillar selected from the support pillars or the transition pillar at least partially overlaps in a perpendicular direction to a fluid flow direction with another pillar selected from the support pillars, the transition pillar, or the filter pillars.

5. The chemical reactor according to claim 1, wherein the support pillars have an average diameter greater than an average diameter of the filter pillars.

6. The chemical reactor according to claim 1, wherein an input void span proximate to the inlet is smaller than or equal to each segment of an output void span in the transition region.

7. The chemical reactor according to claim 1, wherein the support pillars furcate a flow into a furcated flow path between the filter entrance and a first transition edge, wherein the transition edge is located in the transition region where a step from a depth of d_{high} to d_{low} occurs.

8. The chemical reactor according to claim 7, wherein a furcated path width perpendicular to the furcated flow path is substantially equal throughout the furcated flow path.

9. The chemical reactor according to claim 7, wherein the furcated path width is substantially equal to an input void span.

10. The chemical reactor according to claim 1, wherein the inlet depth is d_{high} in the depth direction.

11. The chemical reactor according to claim 1, wherein the separation or processing element includes separation or processing pillars.

12. The chemical reactor according to claim 1, further comprising an offset between a first transition edge and the filter pillars.

13. The chemical reactor according to claim 1, wherein the support pillars in the first duct have a diamond shaped cross-sectional profile with rounded points.

14. The chemical reactor according to claim 1, further comprising a cover sealing the inlet, the filter, and the separation or processing element, thereby allowing a fluid to flow through the chemical reactor under pressure.

15. The chemical reactor according to claim 14, wherein the substrate is a semiconductor wafer, and the cover is a silicate glass.

16. The chemical reactor according to claim 1, wherein d_{high} is between 1 and 1000 μm.

17. The chemical reactor according to claim 1, further comprising a capillary sealed in the inlet up to a stop.

18. The chemical reactor according to claim 1, wherein the chemical reactor is substantially symmetric about the separation or processing element so that a first end includes the inlet and the filter connected to the separation or processing element and a second end includes a second filter connected to the separation or processing element and a second inlet connected to the second filter.

19. The chemical reactor according to claim 1, wherein the support pillars and transition pillar provide a first void span measured in a first direction parallel to a bottom of the substrate such that a length of each segment of the first void span is in a range of 0.2 to 0.5 times an overall entrance width of the second duct.

20. The chemical reactor according to claim 1, wherein the transition pillars are configured to provide a third void span including multiple segments measured in a second direction that is parallel to the bottom, and
wherein a pressure compliance of the reactor is at least 10%, at least 20%, at least 30%, at least 50%, at least 75%, or at least 100% greater than a pressure compliance of a reactor having a comparable single-segment void span.

21-22. (canceled)
